(19) United States
(12) Patent Application Publication
(10) Pub. No.: US 2006/0246187 A1
(43) Pub. Date: Nov. 2, 2006

(54) Food delivery apparatus and method of use

(76) Inventors: Vincent S. Egolf, Ankeny, IA (US); Melissa A. Egolf, Ankeny, IA (US)

Correspondence Address: Vincent S. Egolf;Unit 101, 1523 N. Artesian Avenue, Chicago, IL, 60622, US

(21) Appl. No.: 11/174,106

(22) Filed: Jul. 1, 2005

Related U.S. Application Data
(60) Provisional application No. 60/585,164, filed on Jul. 2, 2004.

(51) Int. Cl. A23L 1/00

(52) U.S. Cl. 426/116

(57) ABSTRACT

A food delivery apparatus that includes a container having a nozzle and a moveable bottom opposite the nozzle, a food product held within the container, and an applicator used to move the bottom toward the nozzle. A method of dispensing the food product from the container including positioning the nozzle to the mouth of a user and engaging the applicator to dispense the food product through the nozzle of the container. The method also including the step of placing a removable tip upon the nozzle to protect the nozzle from contaminates. A kit for delivering food product to the user including a container having a nozzle upon a first end and an opening at a second end, a food product to be placed into the container, and a bottom for fitting within the container.

### REFERENCE TO EARLIER FILED APPLICATION

This application claims priority to provisional application Ser. No. 60/585,164 filed Jul. 2, 2004.

### BACKGROUND OF THE INVENTION

The invention generally pertains to an apparatus that conveys a food product from a container to a user and specifically an apparatus that maintains food in a packaging which may be pressed out of an opening at one end by a fitting moved into a second end of the apparatus.

There are many products that are viscous that may be compressed out of a container. These products include peanut butter, honey, jelly, mayonnaise, and gelatin dessert. These products often require use of a utensil to scoop them out of their container and, in the case of condiments and other spreadables, spread with a knife. Therefore, one inherent problem in the prior art is that the containers require the use of utensils to dispense. Accordingly, an objective of the present invention is the provision of a food product apparatus that enables a user to fill and/or use packaging which permits the user to dispense it conveniently without a utensil.

Another problem found in the prior art is that food products stored in regular containers often have an empty dead space in which oxygen remains in contact with the food products. For example, a jelly container once opened and a portion of the food product removed, has oxygen and other contaminants exposing the unused portion of jelly. Therefore, a further objective of the present invention is to provide a food packaging which does not expose the food product to air and eliminates any dead space that would expose the food product to contaminants.

Specifically with regards to gelatin products and specifically gelatin dessert, there are problems associated with making the gelatin product, storing the product until it sets up, and then serving the product to users. Gelatin products are made using hot liquid to dissolve the powdered gelatin and sugar components. The liquid gelatin product then must be stored in a container in a refrigerated environment in order to go from its liquid form to its solid form. The user typically stores gelatin on cookie sheets, casserole dishes, and/or cups. These items should be covered in the refrigerator to prevent contaminants from sitting on the container. Whether covered or not, these containers are often inconvenient in the refrigerator and if bumped may spill gelatin in a refrigerator which is then difficult to clean. Once set, the user then pulls out the container and must serve the gelatin to a user with a utensil which is sometimes a knife which cuts the gelatin into squares or a spoon which serves the gelatin to a user directly or into a serving dish. Accordingly, a further objective of the present invention is the development of an apparatus and method of using a food product apparatus which effectively helps a user store gelatin products in the refrigerator and to serve them to the users at a later time.

A further problem regarding gelatin products or other products such as pudding is the inclusion of alcohol in them to make an adult food product. The user which is utilizing gelatin or pudding in this fashion is often called making gelatin shots, Jello® shots or pudding shots. The user making these is faced with a primary problem of finding a suitable container for their shots. In addition, the greater alcohol content gelatin shots do not set as firmly as regular gelatin dessert. Therefore, the user is often faced with the dilemma of putting the shots into a cookie tray, casserole dish, or miniature plastic cups. Regardless of which open top container the user chooses, the user will often find it difficult for the product to set up in the refrigerator, difficult to serve, and difficult to keep outside the refrigerator without rapid softening of the gelatin shots. When using pudding, the user is left with little choice of using anything but a casserole dish which must then later be dished into individual serving cups as the pudding does not set entirely into a form which may be cut and presented on a serving tray. Additionally, the user encounters storage difficulties as trays and cups require a large amount of storage area and limits the amount of gelatin product produced and/or stored. Accordingly, a still further objective of the present invention is the provision of a food delivery apparatus which solves the problems faced by those making gelatin or pudding shots.

A still further objective of the present invention is a novel food delivery apparatus which is fun for the user to utilize and promotes the food product with an entertaining device. Accordingly, a still further objective of the present invention is a food delivery product and method of use that is fun and easy to use and is readily identified as a fun food product.

A still further objective of the present invention is a device that is easily disposed and/or reusable.

A still further objective of the present invention is a food delivery apparatus that is sanitary for consumer use.

A still further objective of the present invention is a product which is economical to produce and durable in use.

These and other objectives will become apparent from the specification and claims.

### BRIEF DESCRIPTION OF THE DRAWINGS

FIG. 1 is a side elevation view of the food dispensing apparatus having an inner portion exposed.

FIG. 2 is a side perspective view of a cap for covering the open nozzle of the food dispensing apparatus.

FIG. 3 is a side perspective view of an open ended cap for sanitary dispensing of a food product from within the food dispensing apparatus.

FIG. 4 is a side perspective view of a plastic sleeve to be placed on the open nozzle of the food dispensing apparatus for sanitary delivery of food products.

FIG. 5 is a side exploded view of a food container or cartridge that has a nozzle portion separable from a main body.

FIG. 6 is an illustration of the filling and cooling steps of preparing the food product within the food cartridge.

FIG. 7 is an illustration of the dispensing step of administering a food product to a consumer.

### DETAILED DESCRIPTION OF THE PREFERRED EMBODIMENT

As referred to in the figures, the food delivery apparatus is represented by the numeral 10. The apparatus 10 utilizes a food container 12 that is generally shaped as a caulking tube. The container 12 has a tubular body 14 having a nozzle 16 at one end and an opening 18 at an opposite end.

The nozzle 16 is closed during filling of the tubular body 14 with a food product 20. The nozzle 16 may be preformed as closed and opened using a cutting tool, closed using a cap placed upon the open end of the nozzle, or closed by a residual amount of food product hardening within the nozzle which may later be squeezed out. The opening at the front of the nozzle is generally referred to by the number 22.

A moveable bottom or cap 24 closes the opening 18 opposite the nozzle 16 to prevent food product 20 from escaping out the opening 18 opposite the nozzle when filled with product. The moveable cap 24 slides inside the tubular body 14. When a nozzle opening 22 is upon the nozzle 16, movement of the moveable cap 24 inside the tubular body 14 presses food product 20 out of nozzle opening 22.

An applicator 26 is used to hold the container 12 and deliver food product 20 through the nozzle opening 22. The applicator has a main body 28, a container holding member 30 attached to the body, a handle 32 attached to the body, and a trigger 34 pivotally attached to the body at pivot 36 such that the trigger 34 may move downward toward the handle 32. Upon the handle is a cutting area 38 that utilizes a knife arm upon the trigger 34 to cut the nozzle opening 22 when the nozzle 16 is inserted into the cutter 38.

Movement of the trigger 34 moves a rod 40 and a plunger 42 attached to the rod 40 against the moveable cap 24. The rod 40 is prevented from backward movement by locking member 44. When the user wishes to remove the plunger 42 and rod 40 from the container holding member 30 the user pulls back upon a rod handle 46 to move the rod 40 and plunger 42 backward through the container holding member 30 and the container 12 and the container holding member 30.

The container 12 is made of a food grade material. The container may be made out of a clear plastic material to expose the color of the food product 20 within the container.

When using a clear container 12, it is desirable to have a light 48 upon the plunger to illuminate the food product 20. The light 48 may be a light emitting diode (LED), strobe, or other form of light. An electric source and circuitry is provided on the applicator 26 to illuminate, provide flashing/blinking instructions, and other commands to the light 48.

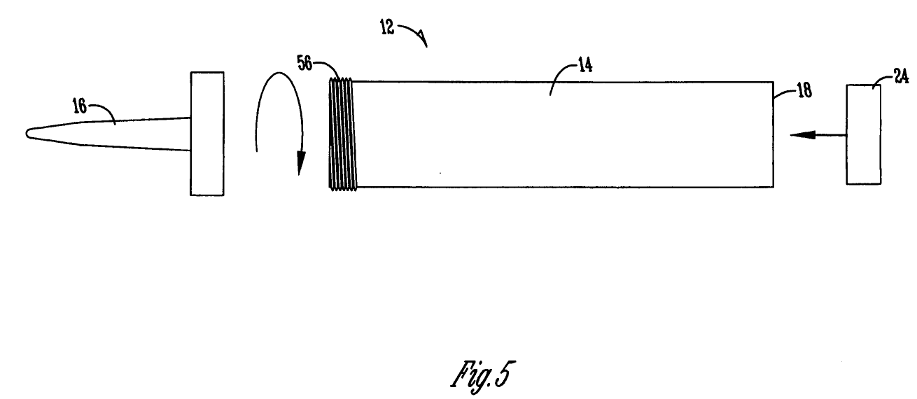

As seen in FIG. 2, a cap 50 may be provided that closes the nozzle opening 22 of the nozzle 16. The cap 50 may include threads or other fastener which secures the cap 50 to the nozzle 16. The cap 50 prevents leakage of the food product 20 from the nozzle opening 22 and contaminants and air from entering into the nozzle to contaminate the food products 20.

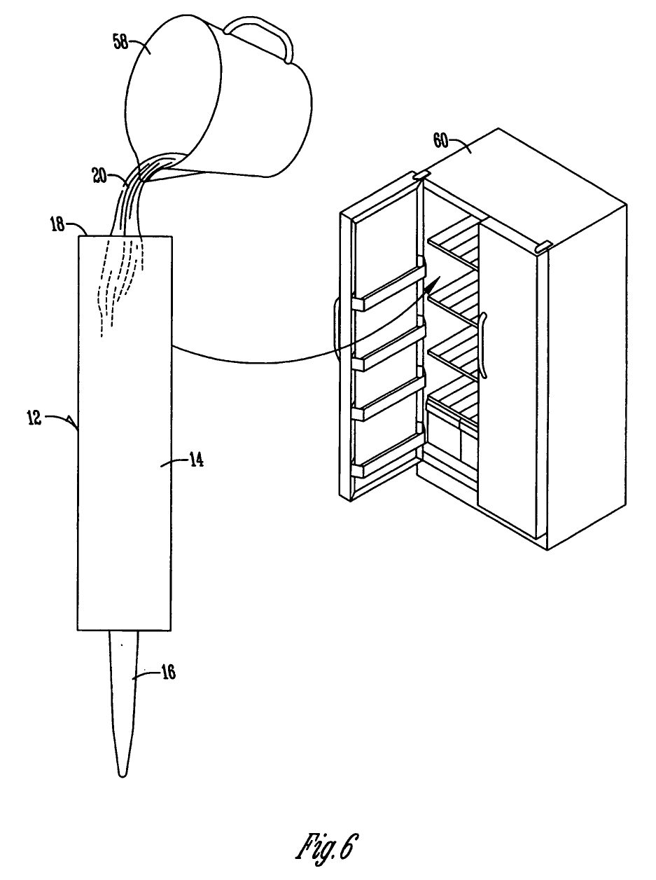

The food delivery apparatus 10 may place food product 20 directly into a user's mouth without contacting the user's lips or mouth and therefore does not require a removable tip 52 or sleeve 54. Alternatively, as seen in FIG. 3, when used for placing food product directly into the mouth of a user the tip 52 may be used. The tip 52 may taper outward to prevent a user's mouth from going over the back rim thus assuring the nozzle 16 is a sanitary tip that only permits one user's mouth from contacting the tip 52 and not be able to touch the nozzle 16. Typically, the open end tip 52 is used when the food delivery apparatus 10 is used for more than one person as in a restaurant, night club, and/or a social gathering. Caps 50 and tips 52 as illustrated are typically of food grade plastic. Alternatively, a sanitary tip may be in the form of a plastic sleeve 54 as seen in FIG. 4 and numbered 54. Both the open tip 52 and the plastic sleeve 54 fit over the nozzle 16 to provide an open end for food product 20 to be dispensed through. Alternatively, a nozzle 16 can be made to separate from the tubular body 14 so each user has their own sanitary nozzle 16.

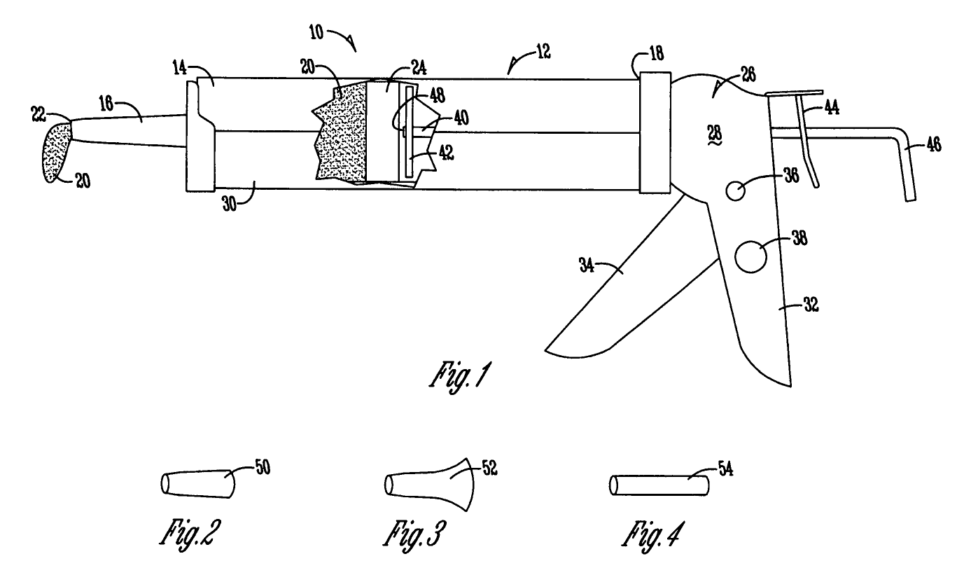

As seen in FIG. 5, the container 12 may be connected to the nozzle by a threaded fastener 56. As previously seen in FIG. 1, the container 12 and nozzle 16 were formed in one piece together whereas in FIG. 5 the nozzle 16 is separate from the tubular body 14 of the container 12. The container 12 is assembled by rotating the nozzle 16 onto the tubular body 14 on threads 56. Alternatively, the nozzle 16 is placed on the tubular body 14 by a snap-fitting, a twist-lock, a helix, etc.

The assembly of container 12 is completed by placing the moveable bottom 24 into opening 18. It should be noted that the moveable bottom 24 is preferably biased towards movement in a one-way direction through the tubular body 14 in a direction from the opening 18 to the nozzle 16. The removable nozzle 16 is positioned on the tubular body to enable the moveable bottom 24 to be popped out of the threaded area so that the tubular body and nozzle 16 may be cleaned and reused. As shown in FIG. 5, the nozzle does not have a nozzle opening 22 cut into it. For reuse, a nozzle cap would be used after a nozzle opening 22 has been cut into the nozzle 16. Alternatively, the nozzle 16 would be preformed with a nozzle opening 22 that accepts a closed end tip.

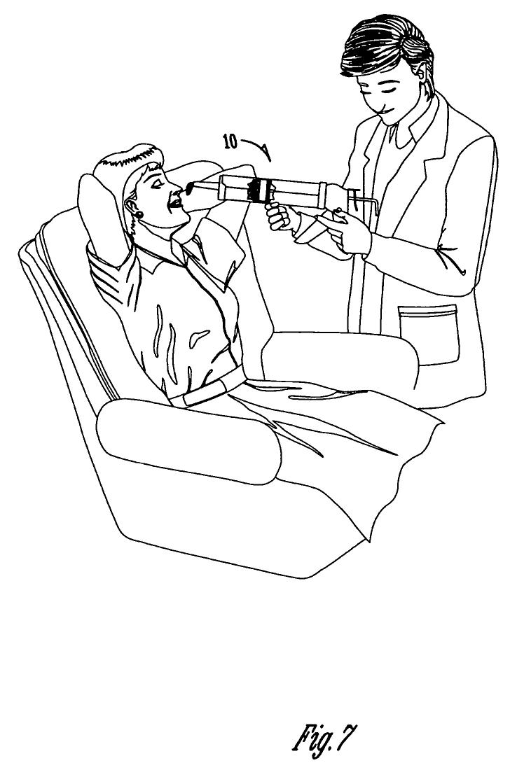

As illustrated in FIG. 6, food product 20 is prepared and placed into container 12. The food product being poured from cup 58 into the opening 18 of the container 12 is a liquid. The container 12 is particularly useful for holding liquids and especially the hot liquids associated with a gelatin mixture as there is no spilling once the moveable bottom 24 seals the opening 18. To maximize the amount of food product 20 within the container 12, the user expels any air remaining at the top of the container by gently squeezing on the tubular body at the opening 18 and slowly working the moveable cap into the tubular body 14. Alternatively, machinery may be used to produce, fill, and seal the product into containers. The container 12, once sealed with moveable bottom 24, is stored in a refrigerated area or refrigerator 60 to solidify. Many recipes of gelatin, pudding, or condiments or other food products may be stored in the container as it takes minimum viscosity to keep the food product 20 within the container once the nozzle has been opened. When placing already solidified products into the container 12, it is useful for the user to expel the air by lifting the packaging nozzle side up and moving the bottom 24 to push air out.

The food delivery apparatus 10 may come as a kit to the user. The kit includes at least one caulking tube 14, a food product for placement within the container, and at least one bottom for fitting with the caulking tube 14. Additinonally, the kit may include an applicator gun 26. A common kit may include three caulking tubes 14 that hold approximately 10-12 ounces of product each. The kit may be provided with directions for assembly and use. A common gelatin mix is approximately 2.5-4.0 ounces of dry mix and directions for making a gelatin dessert or gelatin shot. The gelatin mix makes approximately 3.5-4.5 cups of liquid gelatin that is used to fill all three tubes 14. The tubes are filled to ½ to 1 inch below the opening 18 of the tube 16. The bottom 24 is then placed into the opening and gently pressed into place. The sides of the tube 16 may be gently squeezed to help fit the bottom 24 into place and to relieve excess air within the tube 16. The tubes 16 may then rest upon their side in a refrigerator for approximately 8 hours or until the liquid gelatin dessert forms a gel. Once cool, the tip 16 of the tube 14 may be opened and food product 20 dispensed.

Using the applicator gun 26, the food product 20 may be dispensed from the container 12 through a nozzle opening 22 directly into a user's mouth or the user may dispense food product 20 into another person's mouth. A further dispensing step may include placing a nozzle tip guard 52 upon the nozzle 16 to protect contamination of the food product 20 from a first user's saliva so that it does not come in contact with a second user. When using this step, the user then replaces the nozzle tip 52 between each user with a new nozzle tip 52. The nozzle tip may be disposable. The food product 20 held in the container 12 may be between one ounce and 32 ounces, but most typically is approximately 10-12 ounces. The applicator 26 typically dispenses the food product out in 0.5-1.5 ounce increments, but this may be adjusted based upon the action of the trigger 34 moving to the handle 32.

The food delivery product may be used to deliver products to multiple consumers. The food product cartridges may come in an assembly that has multiple food cartridges in alignment such as in a backpack configuration so that the user may select between different varieties of food product. The method steps may include use with a food product holder that is held on a backpack and push/pull cart that can deliver viscous food product through a nozzle by compressed air, mechanically, etc.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstance may suggest or render expedient without departing from the spirit or scope of the invention as further defined in the following claims.

What is claimed is:

1. A food delivery apparatus comprising:
a container having a tubular body with a nozzle upon a first end and an opening at an opposite second end;
a food product within the container;
a moveable bottom fitted within the opening to hold the food product within the container and shiftable toward the nozzle to dispense the food product out the nozzle;
an applicator used to move the bottom toward the nozzle.

2. The food delivery apparatus of claim 1 wherein the food product is a gelatin dessert.

3. The food delivery apparatus of claim 1 wherein the nozzle is cut to create an opening for food product to be dispensed.

4. The food delivery apparatus of claim 1 further comprising a removable tip placed upon the nozzle to protect the nozzle from contaminates.

5. The food delivery apparatus of claim 4 wherein the tip is food grade plastic.

6. The food delivery apparatus of claim 4 wherein the tip is a removable sleeve.

7. The food delivery apparatus of claim 1 wherein the applicator includes a plunger and a rod to press against the moveable bottom of the container, the plunger including an illuminator projecting light into the food product.

8. The food delivery apparatus of claim 7 wherein the illuminator flashes.

9. The food delivery apparatus of claim 1 further comprising a cap to close an open nozzle.

10. The food delivery apparatus of claim 1 wherein the first end is detachable from the tubular body to permit the bottom to be pushed through an opening created by detaching the first end from the tubular body.

11. A method of delivering a food product to a user comprising:
providing a food product within a container having an open nozzle upon a first end and a moveable bottom at a second end;
providing an applicator used to move the bottom toward the nozzle;
joining the container with the applicator;
positioning the nozzle adjacent a mouth of the user;
engaging the applicator to dispense the food product through the nozzle of the container.

12. The method of claim 11 further comprising the steps providing a closed nozzle and cutting the nozzle.

13. The method of claim 12 further comprising the step covering the opening with a cap.

14. The method of claim 11 further comprising the step placing a removable tip upon the nozzle to protect the nozzle from contaminates.

15. The method of claim 14 further comprising the step replacing the removable tip before use by a second user.

16. A kit for delivering a food product to a user comprising:
at least one container having a tubular body with a nozzle upon a first end and an opening at an opposite second end;
a food product for placement within the container;
at least one bottom for fitting within the opening to hold the food product within the container, the bottom shiftable toward the nozzle to dispense the food product out the nozzle.

17. The kit of claim 16 further comprising assembly directions.

18. The kit of claim 16 wherein the food product is a gelatin mix.

19. The kit of claim 16 further comprising an applicator gun that receives the container.

20. The kit of claim 16 wherein at least three containers and three bottoms are provided.
